(19) United States
(12) Patent Application Publication
(10) Pub. No.: US 2017/0228791 A1
(43) Pub. Date: Aug. 10, 2017

(54) PROXY IDENTITY MANAGEMENT SYSTEM

(71) Applicant: PAYPAL, INC., San Jose, CA (US)

(72) Inventor: Eric Byungho Min, San Jose, CA (US)

(21) Appl. No.: 15/040,430

(22) Filed: Feb. 10, 2016

(51) Int. Cl. G06Q 30/02; H04L 29/08

(52) U.S. Cl. CPC G06Q 30/0271; H04L 67/2804; H04L 67/10; H04L 67/02; G06Q 30/0261

(57) ABSTRACT

Systems and methods for providing proxy identity management includes receiving, from a first device, a first proxy identifier associated with a first website, and associating the first proxy identifier with first proxy identity information. The first proxy identity information is provided to the first device. First marketing information associated with the first proxy identity information is received from a marketing service provider device. A first marketing materials management configuration associated with the first proxy identity information is retrieved. The first marketing information is provided for display on a customer device according to the first marketing materials management configuration.

### BACKGROUND

The present disclosure generally relates to proxy identities used over electronic networks and more particularly to a proxy identity management system that allows customers to receive targeted marketing without revealing their true identities to merchants or other marketers over the electronic networks by using proxy identities.

More and more consumers are conducting transactions, such as purchasing items and services, over electronic networks such as, for example, the Internet. Consumers routinely purchase products and services from merchants and individuals alike. The transactions may take place directly between a physical or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Targeted marketing provides customized marketing materials (e.g., recommendations, offers, loyalty awards) according to a customer's preferences and characteristics (e.g., demographic and psychographic attributes) and is usually more effective than mass marketing, and may provide the customer with more relevant information. A significant tradeoff for the customer to enjoy the benefits of targeted marketing is the need to share personal information over the electronic networks. For example, to receive effective targeted offers, it is usually necessary to provide personal information (e.g., personally identifiable information (PII)) such as name, shipping address, telephone number, email address, credit card numbers, billing address, and/or other types of personal information. Providing such personal information concerns customers because once submitted to a website (e.g., a merchant website, a social network website, a financial service provider website, and/or a payment service provider website), the customers may in some cases lose control of the use of the provided personal information. For example, the email address may be used by online marketers and merchants to send the customer “spam” emails. This concern may prevent some users from providing personal information to receive effective targeted marketing.

Embodiments described herein provide for a system for allowing customers to receive targeted marketing without revealing their true identities to merchants or other marketers over the electronic networks.

### BRIEF DESCRIPTION OF THE FIGURES

FIG. 1 is a flow chart illustrating an embodiment of a method for providing proxy identity management;

FIG. 2 is a screen shot illustrating an embodiment of a customer device displaying a shopping checkout screen;

FIG. 3 is a screen shot illustrating an embodiment of a customer device displaying a proxy identities summary screen;

FIG. 4A is a screen shot illustrating an embodiment of a customer device displaying a proxy identity details screen;

FIG. 4B is a screen shot illustrating an embodiment of a customer device displaying a proxy identity details screen;

FIG. 5 is a screen shot illustrating an embodiment of a customer device displaying an order review screen;

FIG. 6A is a schematic view illustrating an embodiment of a proxy identity management system.

FIG. 6B is a screen shot illustrating an embodiment of a customer device displaying a real identity information screen.

FIG. 6C is a screen shot illustrating an embodiment of a third party service provider device displaying a real shipping address screen.

FIG. 6D is a screen shot illustrating an embodiment of a customer device displaying a shipping cost update notification screen.

FIG. 6E is a screen shot illustrating an embodiment of a third party service provider device displaying a real financial information screen.

FIG. 7 is a screen shot illustrating an embodiment of a customer device displaying a marketing preference configuration screen;

FIG. 8 is a screen shot illustrating an embodiment of a customer device displaying an marketing materials management configuration screen;

FIG. 9A is a screen shot illustrating an embodiment of a customer device displaying a marketing materials dashboard screen.

FIG. 9B is a screen shot illustrating an embodiment of a customer device displaying an offer notification screen.

FIG. 10 is a schematic view illustrating an embodiment of a networked system;

FIG. 11 is a perspective view illustrating an embodiment of a customer device;

FIG. 12 is a schematic view illustrating an embodiment of a computer system; and

FIG. 13 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing proxy identity and targeted marketing management. As discussed above, customers may be concerned about the personal information they provide to various websites (e.g., merchant websites, social network websites, financial service provider websites, payment service provider websites and/or any other websites known in the art), which may prevent some customers from conducting online transactions to make purchases, using the services provided by the websites, and/or enjoying the benefits of targeted marketing. To address such concerns, in embodiments of the systems and methods described herein, a system provider (e.g., the payment service provider discussed below) may provide different proxy identities for a particular customer to different merchants (e.g., based on the customer's trust level in the merchants) so that customer may conduct online transactions at the websites and/or receive marketing materials from the websites without revealing their real identity. Moreover, customers may gain the convenience of managing their proxy identities used in various websites using a single system provider. Furthermore, the system provider may receive marketing materials (e.g., from marketing service providers), associate the marketing materials with the proxy identities, and provide the received marketing materials for display on a customer device according to marketing materials management configurations, so that the customer may enjoy the benefit of targeted marketing while controlling distribution of real identity information.

It is noted that while examples of merchants' web sites provided by merchant devices associated with merchants are discussed below, these examples are not intended to be limiting. The proxy identity and targeted marketing management may be provided to websites provided by a variety of website providers (e.g., social network providers, financial service providers, marketing service providers, and/or any other websites providers that may collect personal information from customers accessing the websites and/or provide targeted marketing).

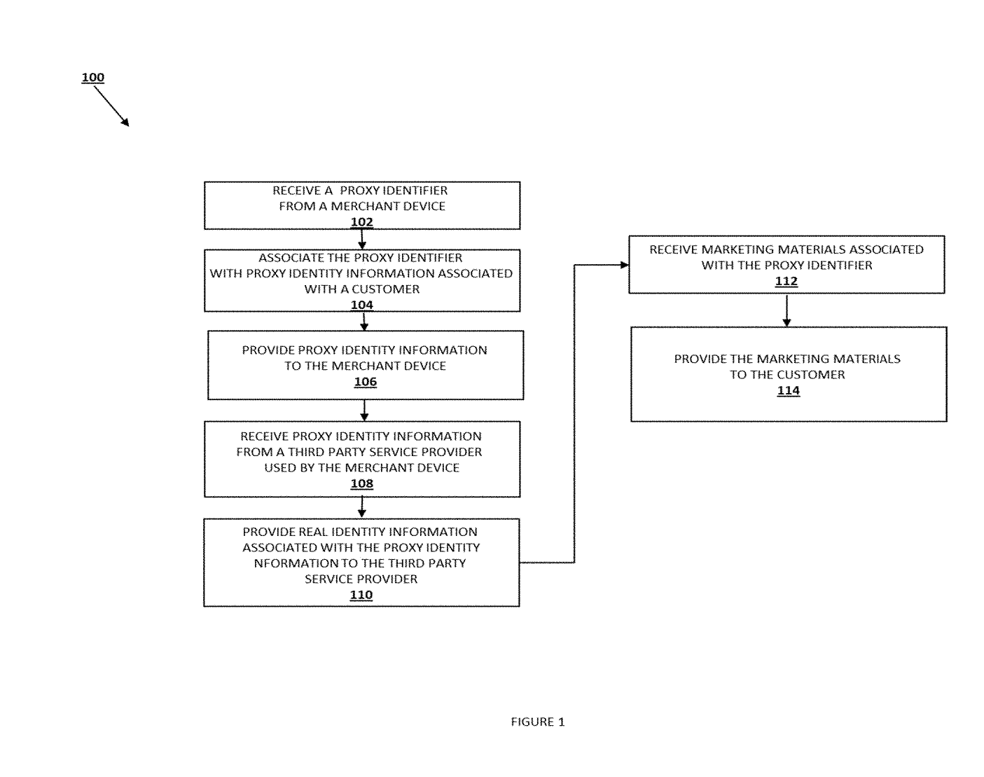

Referring now to FIG. 1, an embodiment of a method 100 for providing proxy identity management is illustrated. In the embodiments discussed below, a payment service provider such as, for example, PayPal, Inc. of San Jose, Calif. is the system provider and operates a system provider device (e.g., payment service provider device) to help the customers manage proxy identities provided to various websites, and receive targeted marketing while controlling distribution of real identity information. However, one of skill in the art in possession of the present disclosure will recognize that a variety of other system providers such as, for example, marketplace providers, merchants, financial service providers, marketing service providers, and/or other entities will benefit from the teachings herein and thus fall within the scope of the present disclosure.

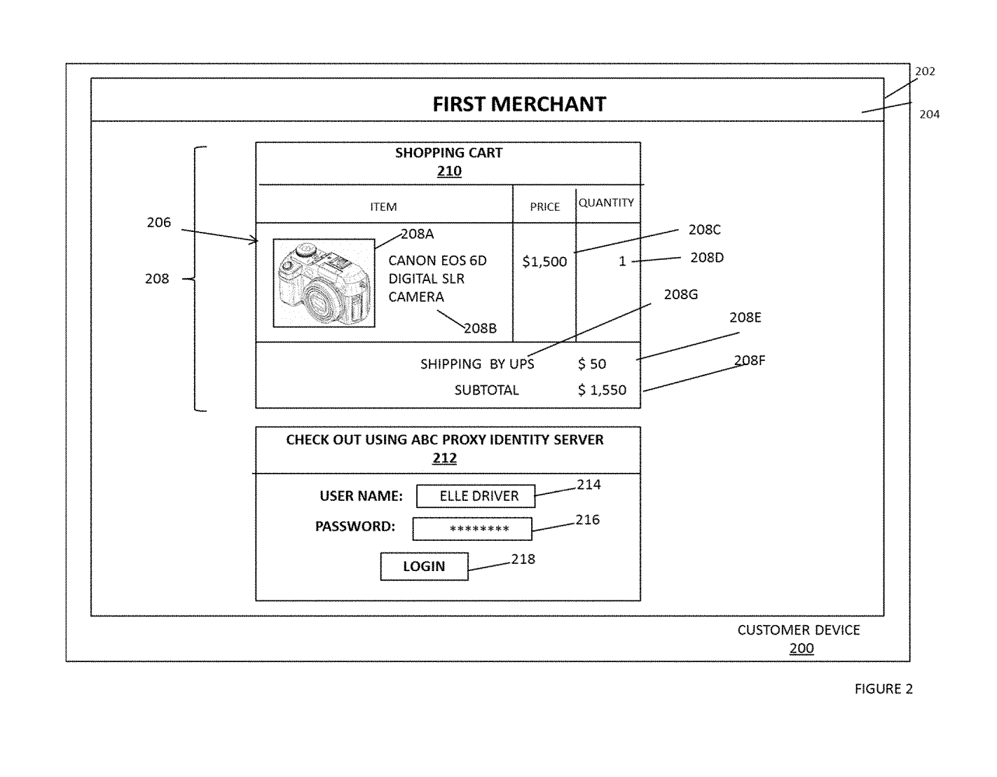

The method may begin at block 102, where the system provider receives a proxy identifier from a merchant device. Referring now to FIG. 2, illustrated is an example of a checkout screen 204 displayed on a display device 202 of the customer device 200 when a customer is shopping online at a merchant's website (e.g., “First Merchant”). In the illustrated example, at this stage, the customer is browsing the merchant's website as a guest (e.g., non-registered or anonymous user that may only be identified by information such as a Media Access Control (MAC) address, an Internet Protocol (IP) address, or other user device identifier). In the particular illustrated example of FIG. 2, the customer has placed an item 206 associated with item information 208 in a shopping cart 210. The item information 208 may include an item image 208A (e.g., an image of the item 206), item details 208B (e.g., “Canon EOS 6D Digital SLR Camera”), price information 208C (e.g., “$1,500”), requested quantity 208D (e.g., “1”), shipping cost information 208E (e.g., “$50”), subtotal information 208F (e.g., “$1,550”), shipping provider information 208G (e.g., “UPS”), and/or other item information known in the art. In some embodiments, the shipping cost information 208E is an estimated shipping cost (e.g., using the IP address) as the merchant device may not have a real shipping address associated with the customer.

In some embodiments, the checkout screen 204 may include a checkout section 212, where a customer may provide a proxy identifier 214 and a password 216. In some embodiments, the customer may submit the proxy identifier 214 (e.g., “ELLE DRIVER”) and the password 216 to the merchant device by selecting the “Login” button 218, and the merchant device may send the proxy identifier 214 and the password 216 to the system provider device. Alternatively, in some embodiments, the checkout section 212 is directly provided by the system provider device (e.g., using a widget), and the proxy identifier 214 and the password 216 may be sent from the customer device 200 to the system provider device over the network without using the merchant device.

Referring back to FIG. 1, the method 100 then proceeds to block 104, where a system provider device may associate proxy identity information with the proxy identifier. In some embodiments, the system provider device may determine that it is the first time that the customer uses the proxy identifier, create new proxy identity information associated with the proxy identifier, and save the proxy identity information (e.g., in the proxy identity management database). In some embodiments, the system provider device may retrieve existing proxy identity information associated with the proxy identifier (e.g., from a proxy identity management database).

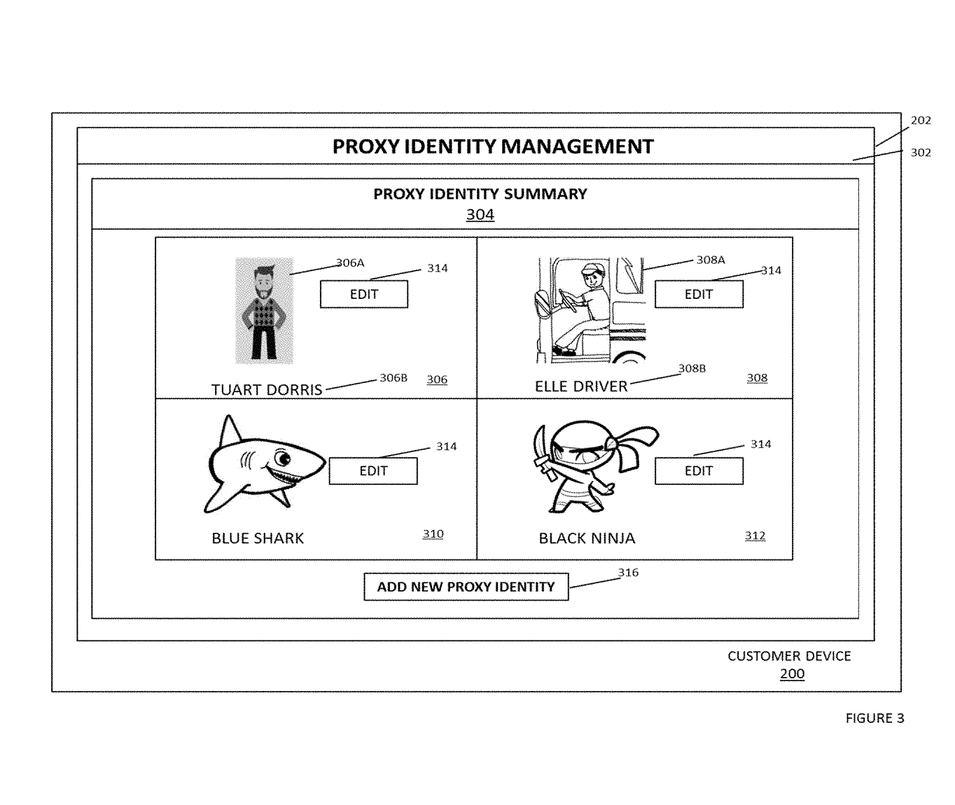

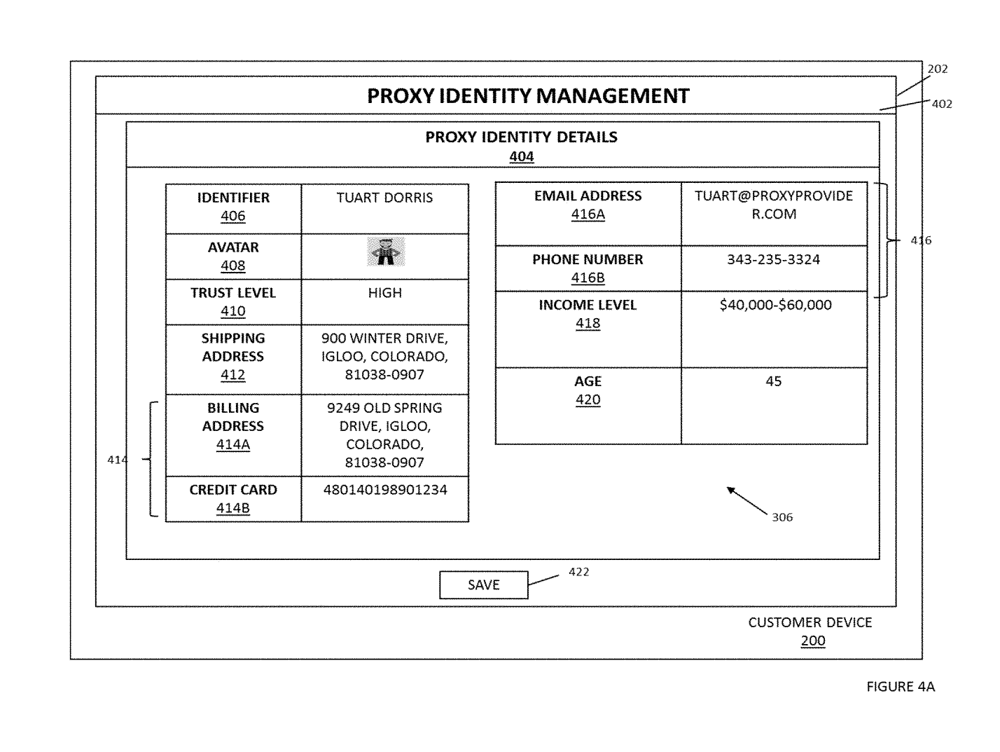

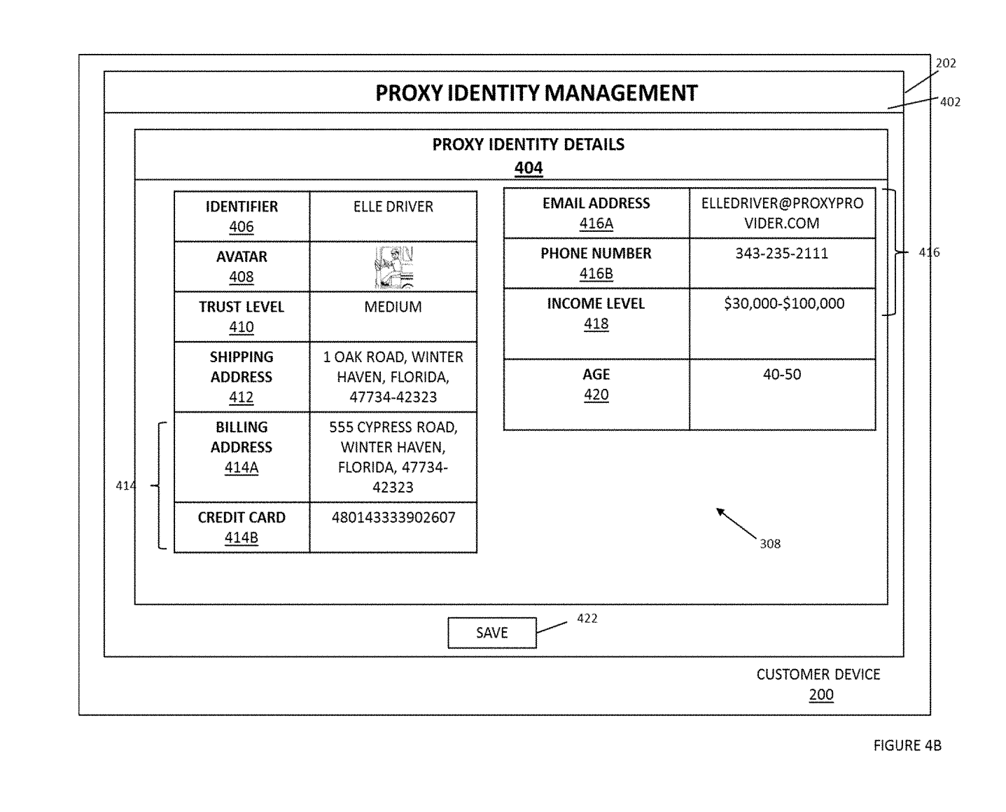

Referring now to FIGS. 3, 4A, and 4B, in various embodiments, the system device provider may allow the customer to review the proxy identity information associated with the customer, add new proxy identity information, remove existing proxy identity information, and/or edit the details of the proxy identity information. Referring now to FIG. 3, illustrated is an example of a proxy identity summary screen 304 displayed on a display device 202 of a customer device 200. The proxy identity summary screen 302 includes a proxy identity summary section 304 including summaries of each proxy identity information associated with the customer. The proxy identity summary section 304 includes a list of proxy identity information 306, 308, 310, and 312 associated with the customer. In some embodiments, a proxy identifier and/or an avatar of each of proxy identity information 306, 308, 310, and 312 may be displayed. In some embodiments, the avatar may be chosen by the customer or provided by the system provider device to help the customer to recall the details of the proxy identity information. In an example, proxy identity information 306 may provide an image of the customer as the avatar 306A associated with the proxy identifier 306B (e.g., “TUART DORRIS”). In another example, proxy identity information 308 may provide an image of a truck driver as the avatar 308A associated with the proxy identifier 308B (e.g., “ELLE DRIVER”). In some embodiments, the customer may select the “Add New Proxy Identity” button 316 to add new proxy identity information. In some embodiments, the customer may select the “Edit” button 314 to modify the details of the selected proxy identity information.

Referring now to FIGS. 4A and 4B, illustrated therein are examples of proxy identity detail screens which may allow the customer to review and edit the details of the proxy identity information (e.g., after selecting the “Edit” button 314). Illustrated in FIG. 4A is an example of a proxy identity detail screen 402 displayed on a display device 202 of a customer device 200. The proxy identity detail screen 402 includes a proxy identity detail section 404, which includes the details of the proxy identity information 306, including the proxy identifier 406 (e.g., “TUART DORRIS”), avatar 408 (e.g., an image representing the proxy identity), and trust level 410 (e.g., “HIGH”), proxy shipping address 412 (e.g., “900 WINTER DRIVE, IGLOO, COLORADO, 81038-0907”), proxy financial proxy information 414 including billing address information 414A (e.g., “9249 OLD SPRING DRIVE, IGLOO, COLORADO, 81038-09079249”) and credit card information 414B (e.g., “480140198901234”), proxy contact information 416 including a proxy email address 416A (e.g., “TUART@PROXYPROVIDER.COM”), a proxy phone number 416B (e.g., “343-235-3324”), proxy income level information 418 (e.g., “$40,000-$60,000”), proxy age information 420 (e.g., “45”), and/or any other proxy identity information. In some embodiments, the proxy contact information 416 including the proxy email address 416A and/or the proxy phone number 416B may include a valid email address or phone number provided by the system provider device, and communications sent to the proxy contact information 416 may be received by the system provider device. Alternatively, in some embodiments, the proxy contact information 416 may include invalid email address or phone numbers, and the system provider device may not receive any communications sent to the proxy contact information 416, and in turn, may not display any of those communications to the customer.

Illustrated in FIG. 4B is another example of a proxy identity detail screen 402 displayed on a display device 202 of a customer device 200. The proxy identity detail screen 402 includes a proxy identity detail section 404, which includes the details of the proxy identity information 308, including the proxy identifier 406 (e.g., “ELLE DRIVER”), avatar 408 (e.g., an image representing the proxy identity information 308), trust level 410 (e.g., “MEDIUM”), proxy shipping address 412 (e.g., “1 OAK ROAD, WINTER HAVEN, FLORIDA, 47734-42323”), proxy financial proxy information 414 including billing address information 414A (e.g., “555 CYPRESS ROAD, WINTER HAVEN, FLORIDA, 47734-42323”) and credit card information 414B (e.g., “480143333902607”), proxy contact information 416 including a proxy email address 416A (e.g., “ELLEDRIVER@PROXYPROVIDER.COM”), a proxy phone number 416B (e.g., “343-235-2111”), proxy income level information 418 (e.g., “$30,000-$100,000”), proxy age information 420 (e.g., “40-45”), and/or any other proxy identity information known in the art.

In some embodiments, the customer may add, remove, and/or edit the details of the proxy identity information. For example, one or more of the proxy identifier 406, the avatar 408, the trust level 410, the proxy shipping address information 412, the proxy financial information 414, the proxy contact information 416, the proxy income level information 418, and/or the proxy age information 420 may be editable by the customer. In some embodiments, the customer may select the “Save” button 422 if the customer would like to save the changes that the customer has made to the proxy identity information.

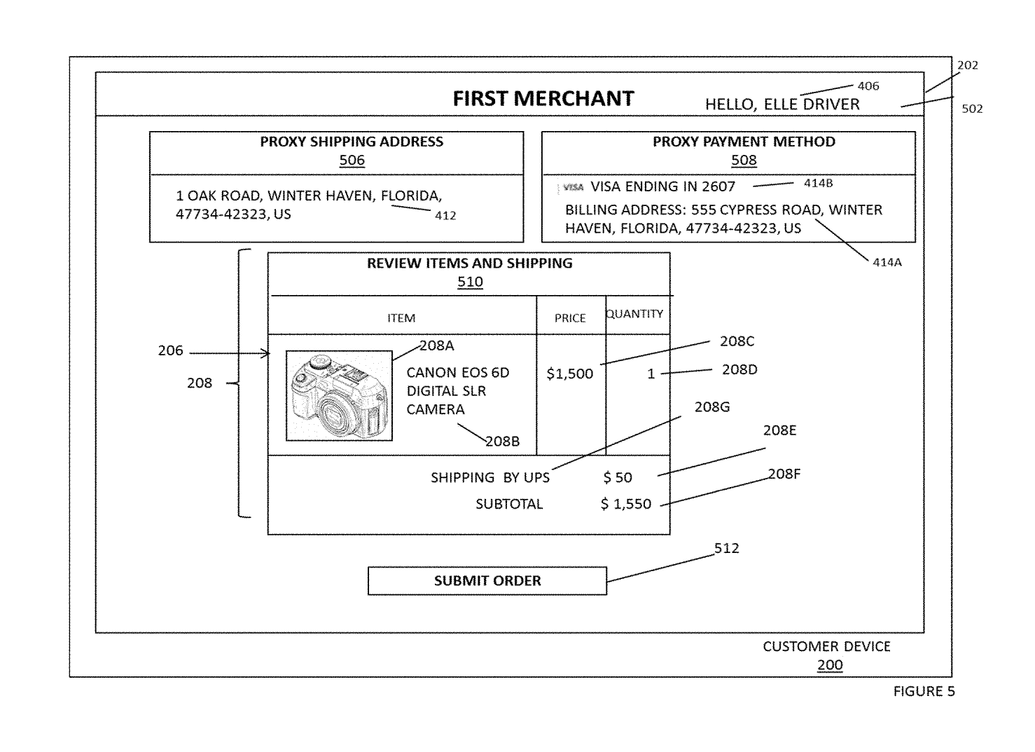

Referring now to FIGS. 1 and 5, the method 100 then proceeds to block 106, where the proxy identity information associated with the proxy identifier is provided to the merchant device. In the illustrated example of FIG. 5, the system provider device determines that the proxy identity information 308 is associated with the proxy identifier “ELLE DRIVER,” and provides the proxy identity information 308 to the merchant device.

Referring now to FIG. 5, illustrated is an example of an order review screen 502 displayed on a display device 202 of a customer device 200 after the merchant device receives the proxy identity information 308 associated with the proxy identifier (e.g., “ELLE DRIVER”). The order review screen 502 includes a shipping address section 506 displaying the proxy shipping address 412 of the proxy identity information 308, and a payment method section 508 displaying the proxy financial information 414 of the proxy identity information 308 (e.g., the proxy billing address information 414A and the proxy credit card information 414B). The order review screen 502 further includes a review items and shipping section 510 which displays the item information 208 for the item 206. In some embodiments, because the merchant device does not have a real shipping address, the shipping cost information 208E is an estimate (e.g., based on the proxy shipping address 412). The customer may select the “SUBMIT ORDER” 512 to place the order for purchasing the item 206.

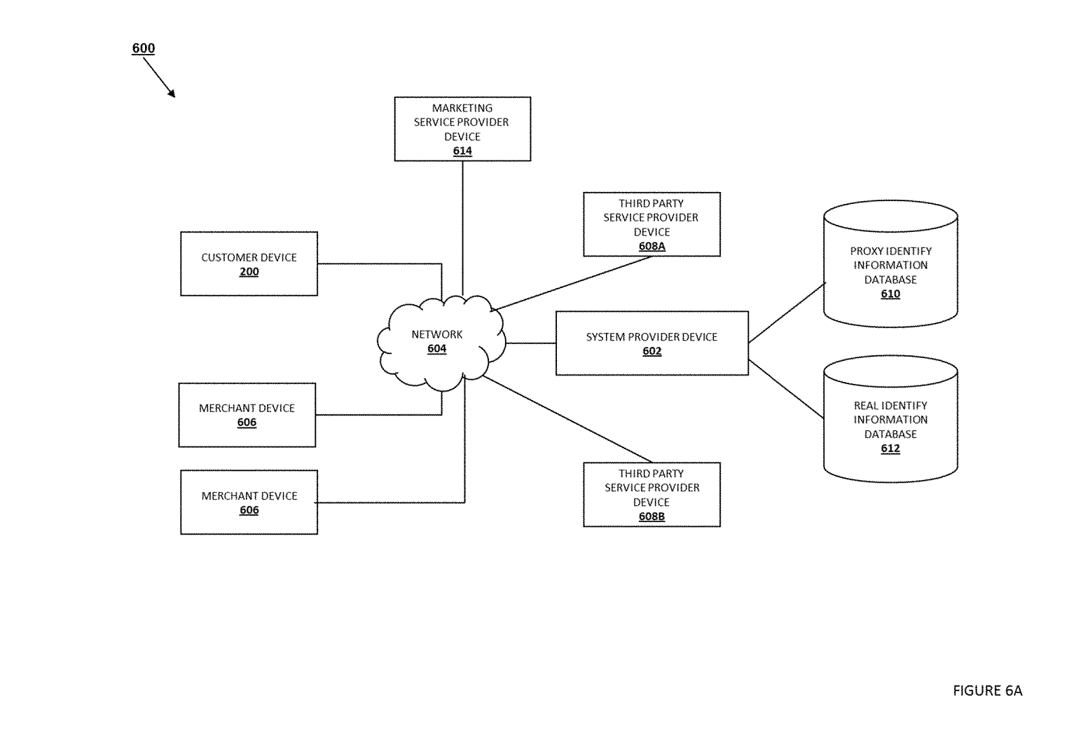

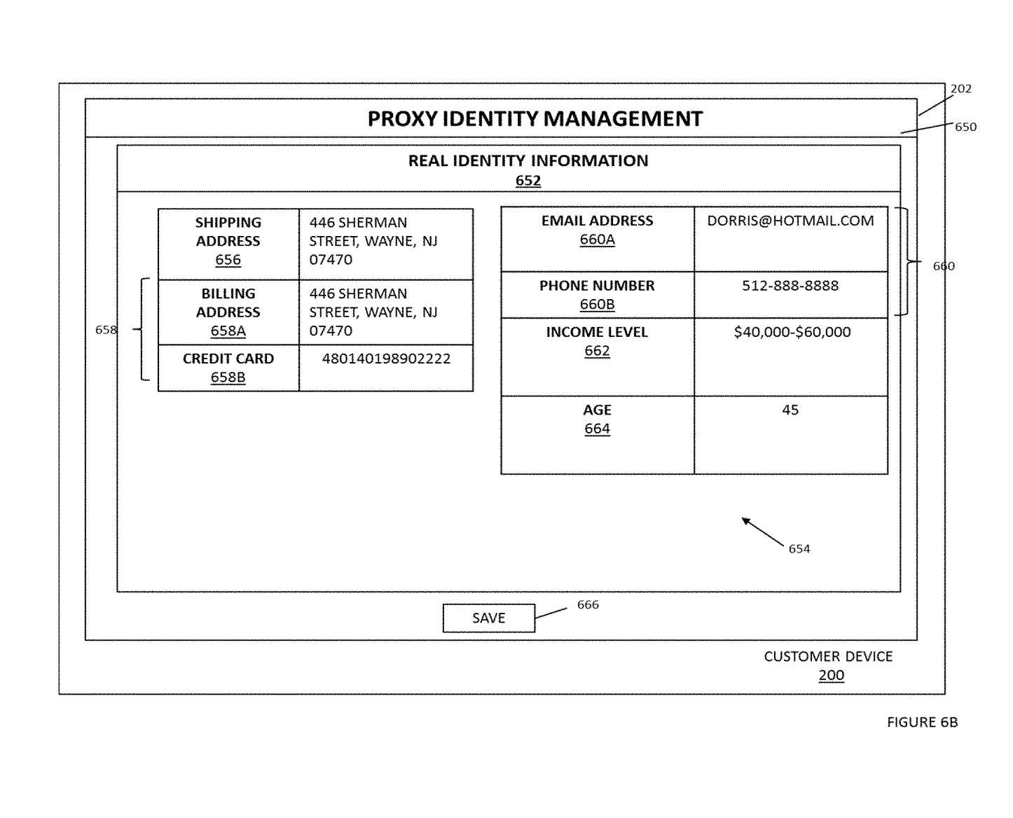

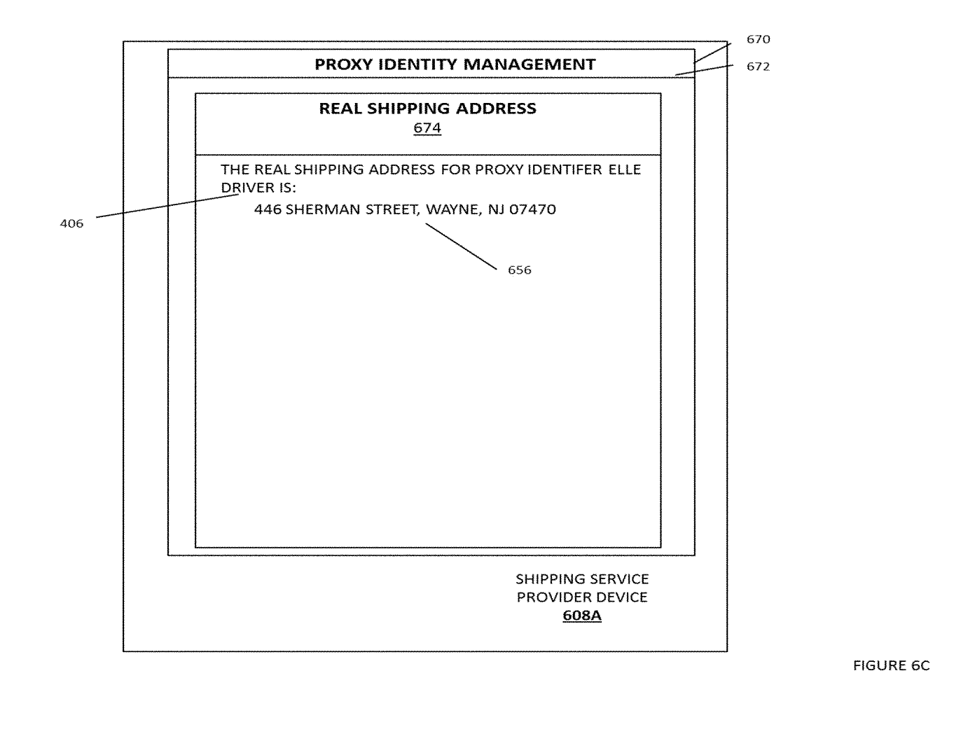

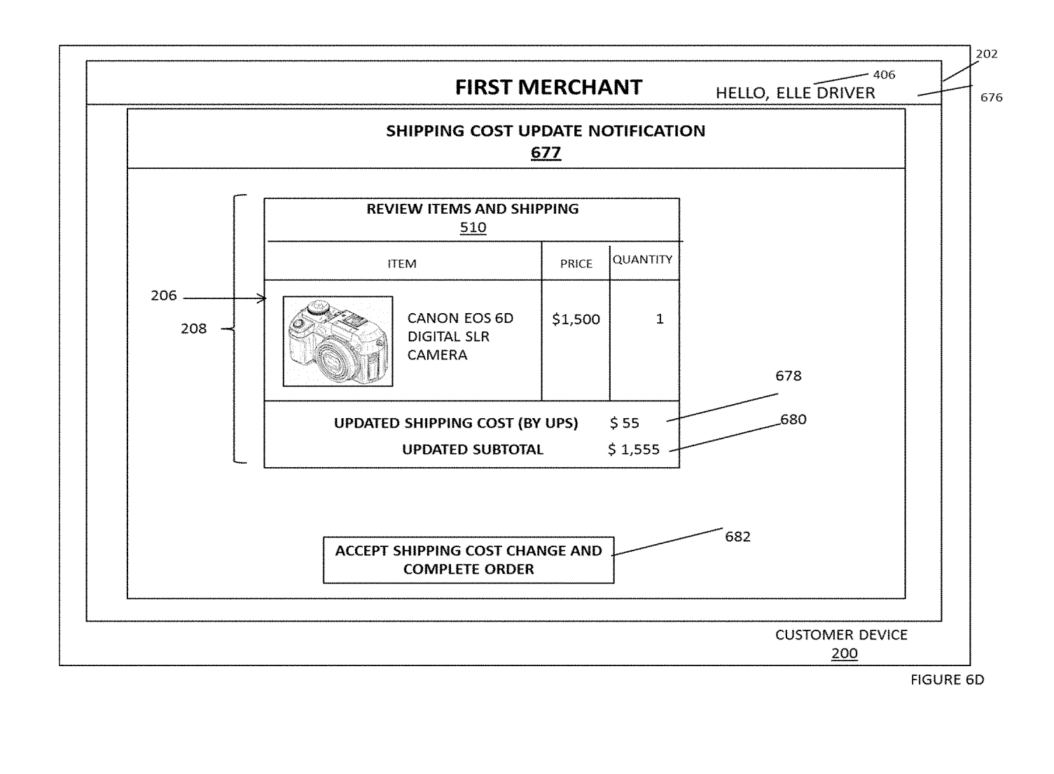

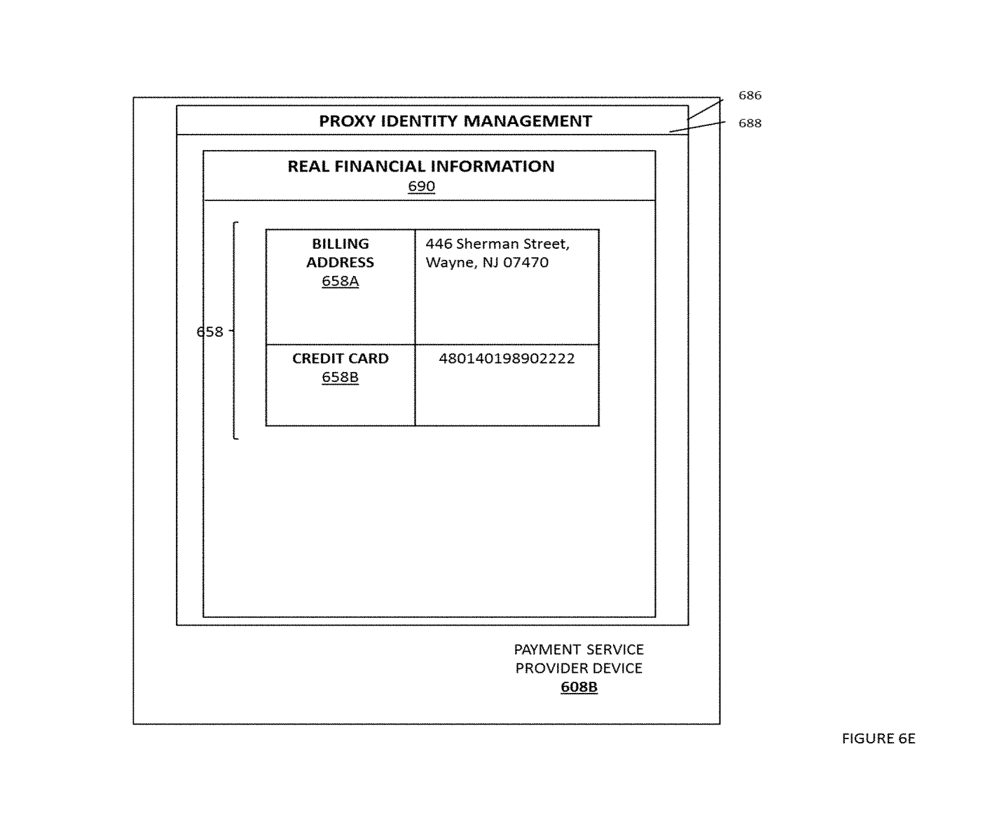

Referring now to FIGS. 1 and 6A-6E, the method 100 then proceeds to block 108, where the system provider device may receive a real identity information request from a third party service provider device used by the merchant device to assist the online transaction between the merchant and the customer. In some embodiments, different types of third party service providers may request different types of real identity information based on the services provided by the third party service provider devices.

Referring now to FIG. 6A, an embodiment of a proxy identity management system 600 including one or more third party service provider devices is illustrated. The proxy identity management system 600 includes a system provider device 602 communicatively coupled through a network 604 to a customer device, merchant devices 606, and marketing service provider device 614. The system provider device 602 is further communicatively coupled to a proxy identity information database 610 and a real identity information database 612. While illustrated as separate databases that are directly connected to the system provider device 602, the proxy identity information databases 610 and real identity information database 612 may be provided in a single database or multiple databases, and/or may be coupled to the system provider device 602 by the network 604. The system provider device 602 is further communicatively coupled to third party service provider devices 608A and 608B. Each of the third party service provider devices 608A and 608B may provide a particular type of service associated with the online transaction. For example, the third party service provider device 608A may be used to provide a shipping service. For further example, the third party service provider device 608B may be used to provide a payment service.

Referring now to FIG. 6B, in some embodiments, real identity information associated with the customer may be provided by the customer to the system provider device 602. Illustrated in FIG. 6B is an example of a real identity information screen 650 displayed on a display device 202 of a customer device 200. The real identity information screen 650 may include a real identity information section 652 displaying the real identity information 654, including a real shipping address 565 (e.g., “446 SHERMAN STREET, WAYNE, NJ 07470”), real billing information 658 including a real billing address 658A (e.g., “446 SHERMAN STREET, WAYNE, NJ 07470”) and real credit card information 658B (e.g., “480140198902222”), real contact information 660 including a real email address 660A (e.g., dorris@hotmail.com), a real phone number 660B (e.g., “512-888-8888”), real income level information 662 (e.g., “$40,000-$60,000”), real age information 664 (e.g., “45”) and/or any other real identity information known in the art. Each type of real identity information may be editable and changed by the customer. In some embodiments, the customer may select the save button 666 if the customer would like to save the changes that the customer has made to the real identity information.

Referring now to FIGS. 6C and 6D, in some embodiments, a shipping service provider device 608A is used by the merchant device to provide a shipping service for the transaction between the merchant and the customer. In some embodiments, the merchant device 606 may send a shipping request to the third party service provider device 608A (e.g., a shipping service provider device providing a shipping service “UPS”) for shipping the item 206 to the customer. In an example, the shipping request may include the proxy identifier 406 of the proxy identity information 308 received by the merchant device 606 from the system provider device 602. In another example, the shipping request may include the proxy shipping address 412 of the proxy identity information 308 received by the merchant device 606 from the system provider device 602. After receiving the shipping request from the merchant device 606, the third party service provider device 608A may send a real identity information request to the system provider device 602. The real identity information request may include the proxy identifier 406, the proxy shipping address information 412, and/or the requested real identity information type (e.g., real shipping address information).

In some embodiments, after receiving the real identity information request from the third party service provider device 608A, the system provider device 602 may determine that the third party service provider device 608A is authorized to receive the requested type of real identity information associated with the customer, and then provide the third party service provider device 608A the requested type of real identity information. In an example, the system provider device 602 may determine that the third party service provider device 608A is authorized to receive the real shipping address information, but not the real financial information associated with the customer, and provide the real shipping address information to the third party service provider device 608A. Illustrated in FIG. 6C is an example of a real shipping address information screen 672 displayed on a display device 670 of the third party service provider device 608A. The real identity information screen 672 may include a real identity information section 674 displaying the real shipping address information 656 (e.g., “446 SHERMAN STREET, WAYNE, NJ 07470”) associated with the proxy identifier 406 (e.g., “ELLE DRIVER”).

Referring now to FIG. 6D, in some embodiments, a shipping cost update notification may be provided to the customer to notify the customer a change in the shipping cost for the item 206. In some embodiments, the system provider device or the third party service provider device 608A may calculate to an updated shipping cost based on the real shipping address information 656, and send the updated shipping cost to the merchant device 606. The merchant device 606 may update the order review screen with the updated shipping cost or send a shipping cost update notification to the customer. Illustrated in FIG. 6D is an example of a shipping cost update notification screen 676 displayed on a display device 202 of the customer device 200. The shipping cost update notification screen 676 may include a shipping cost update notification section 677 displaying a shipping cost update notification including updated shipping cost 678 (e.g., “$55”) and updated subtotal 680 (e.g., “$1,555”). The customer may choose the button 682 to accept the changes in the shipping cost and subtotal, and complete the purchase of the item 206.

Referring now to FIG. 6E, in some embodiments, the customer may request to make a payment to the merchant device 606 for the item 206 using a third party service provider device 608B. The merchant device 606 may send a payment request to the third party service provider device 608B (e.g., a payment service provider device providing a payment service). In some embodiments, the payment request may include the proxy identifier 406 of the proxy identity information 308 received by the merchant device 606 from the system provider device 602. In some embodiments, the payment request may include the proxy financial information 414 of the proxy identity information 308 received by the merchant device 606 from the system provider device 602. After receiving the payment request from the merchant device 606, the third party service provider device 608B may send a real identity information request to the system provider device 602. The real identity information request may include the proxy identifier 406, the proxy financial information 414, and/or the requested real identity information type (e.g., real financial information).

In some embodiments, after receiving the real identity information request from the third party service provider device 608B, the system provider device 602 may determine that the third party service provider device 608B is authorized to receive the requested type of real identity information associated with the customer, and provide the third party service provider device 608B the requested type of real identity information. In an example, the system provider device 602 may determine that the third party service provider device 608B is authorized to receive the real financial information associated with the customer, and provide the real financial information to the third party service provider device 608B. Illustrated in FIG. 6E is an example of a real financial information screen 688 displayed on a display device 686 of the third party service provider device 608B. The real identity information screen 688 may include a real identity information section 690 displaying the real financial information 658 including real billing address information 658A (e.g., “446 SHERMAN STREET, WAYNE, NJ 07470”) and real credit card information 658B (e.g., “480140198902222”). The third party service provider device 608B may use the received the real financial information 658 to finish the payment for the item 206 for the customer. In an example, after the payment is successfully completed, the third party service provider device 608B may provide a payment success notification to one or both of the merchant device and the system provider device. In another example, an error (e.g., wrong billing address) may occur and the payment is not successful, and the third party service provider device 608B may provide a payment error notification to one or both of the merchant device and the system provider device. In response to receiving the payment error notification, the system provider device may request the customer to provide new real financial information (e.g., new real billing address).

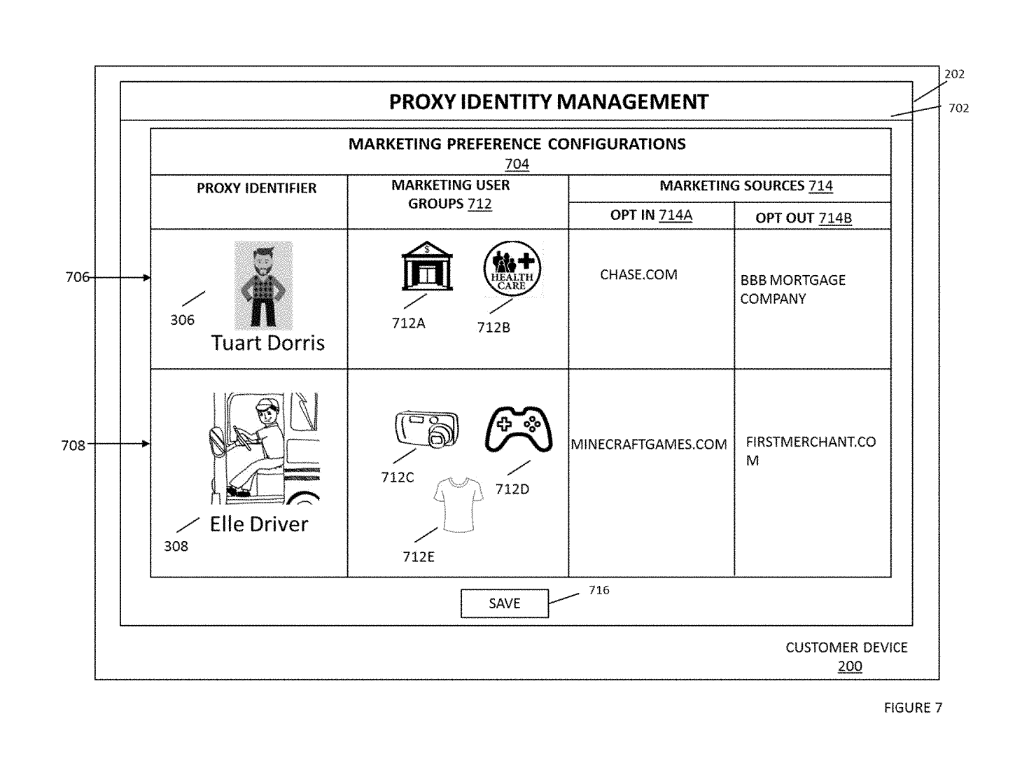

Referring now to FIGS. 1 and 7, the method 100 proceeds to block 112, where the system provider device may receive marketing materials associated with proxy identity information associated with the customer. In various embodiments, the system provider device may receive marketing materials provided by various marketing sources (e.g., the merchant devices, marketing service provider devices, and/or any other marketing sources).

In some embodiments, the marketing sources may have the proxy identity information 308 associated with the customer. In an example, the marketing sources may include the first merchant associated with the merchant device 606, which stores the proxy identity information 308 provided by the system provider device during the online transaction between the first merchant and the customer. In another example, the marketing sources may have purchased the proxy identity information 308 from a merchant (e.g., the first merchant) that the customer visited previously. The marketing sources may provide marketing materials (e.g., loyalty awards, offers, recommendations) using the proxy identity information 308 to the system provider device 602. In some examples, the merchant device 606 may send marketing materials to the system provider device 602 using the proxy contact information 416 (e.g., sending marketing emails to the proxy email address 416A “ELLEDRIVER@PROXYPROVIDER.COM”) of the proxy identity information 308. In some examples, the merchant device 606 may send marketing materials targeted at the demographic attributes (e.g., the income level 418, the age information 420) associated with the proxy identity information 308.

In some embodiments, some marketing sources (e.g., the marketing service provider 614) may have neither real identity information nor proxy identity information about the customer. To enable the customer to receive targeted marketing from those marketing sources, the system provider device 602 may allow the customer to configure various marketing user groups (also referred to as user groups) that the customer would like to join in marketing preference configurations, which may enable the customer to enjoy the benefits of targeted marketing from those marketing sources without revealing real identity information and/or proxy identity information. In various embodiments, the user groups may be defined according to product types or categories (e.g., a particular type of camera), types of services (e.g., credit offers), common interests of the consumers (e.g., shopping to support a particular charity organization), and/or any other ways known in the art to define user groups.

Illustrated in FIG. 7 is an example of a marketing preference configuration screen 702 displayed on a display device 202 of a customer device 200. The marketing preference configuration screen 702 includes a marketing preference configuration section 704 including various marketing preference configurations 706 and 708. For example, the marketing preference configuration 706 may provide that for the proxy identity information 306 (e.g., associated with the proxy identifier “TUART DORRIS”), the customer would like to receive only targeted marketing directed at marketing user group 712A (e.g., user groups associated with banking information and credit offers) and marketing user group 712B (e.g., user groups associated with health care information). In another example, the marketing preference configuration 708 may provide that for the proxy identity information 308, the customer would like to receive only targeted marketing directed at marketing user group 712C (e.g., user groups associated with electronics), marketing user group 712D (e.g., user groups associated with gaming), and marketing user group 712E (e.g., a user group associated with clothing) provided by the marketing service provider 614. In some embodiments, the customer may add, remove, and/or edit the various marketing user groups associated with a particular proxy identifier using the marketing preference configurations, thereby conveniently allowing the customer to change the participation in various user groups.

In some embodiments, the customer may choose to receive (e.g., opt-in) marketing materials and/or opt out of receiving marketing materials from particular marketing sources to the marketing preference configurations may allow the customer to opt-in or opt out marketing materials provided by particular marketing sources. In the example illustrated in FIG. 7, the marketing preference configuration 706 may provide that the proxy identity information 306 may be used to receive marketing materials from opt in marketing sources 714A (e.g., “CHASE.COM,”), but may not be used to receive marketing materials from opt out marketing sources 714B (e.g., “BBB MORTGAGE COMPANY”). In another example, the marketing preference configuration 708 may provide that the proxy identity information 308 may be used to receive marketing materials from marketing sources 714A (e.g., “MINECRAFTGAMES.COM”), but may not be used to receive marketing materials from opt out marketing sources 714B (e.g., “FIRSTMERCHANT.COM”).

In some embodiments, the system provider device 602 may send opt in requests to the marketing sources according to the marketing preference configurations. In an example, according to the marketing preference configuration 706, the system provider device 602 may send an opt in request to the opt in marketing source 714A (e.g., “CHASE.COM”), and subscribe to the marketing emails of the opt in marketing source 714A of the marketing preference configuration 706 using the proxy email address 416A (e.g., “TUART@PROXYPROVIDER.COM”). In another example, according to the marketing preference configuration 708, the system provider device 602 may send an opt in request to the opt in marketing source 714A (e.g., “MINECRAFTGAMES.COM”), and subscribe to the marketing emails of the opt in marketing source 714A of the marketing preference configuration 706 using the proxy email address 416A (e.g., “ELLEDRIVER@PROXYPROVIDER.COM”).

In some embodiments, the system provider device 602 may send opt out requests to the marketing sources according to the marketing preference configurations. In an example, according to the marketing preference configuration 706, the system provider device 602 may send an opt out request to the opt out marketing source 714B (e.g., “BBB MORTGAGE COMPANY”), and unsubscribe the proxy email address 416A (e.g., “TUART@PROXYPROVIDER.COM”) from the marketing emails of the opt out marketing source 714B of the marketing preference configuration 706. In another example, according to the marketing preference configuration 708, the system provider device 602 may send an opt out request to the opt out marketing source 714B (e.g., “FIRSTMERCHANT.COM”), and unsubscribe the proxy email address 416A (e.g., “ELLEDRIVER@PROXYPROVIDER.COM”) from the marketing emails of the opt out marketing source 714B of the marketing preference configuration 708.

In some embodiments, at block 112, the system provider device 602 may receive various marketing materials provided by the marketing service provider 614 and/or the merchant devices 608A/608B according to the marketing preference configurations. In some embodiments, the system provider device 602 may receive marketing materials from the marketing service provider 614 that are targeted at the user group 712C by using an email address assigned to the user group 712C (e.g., “ELECTRONICS@PROXYPROVIDER.COM”). In an example, the system provider device 602 may determine that the customer chooses to participate in the user group 712C by using the proxy identity information 308 according to the marketing preference configuration 708, and associate the received marketing materials at the assigned email address with the proxy identity information 308 (e.g., in a marketing materials database).

In some embodiments, the system provider device 602 may receive marketing materials from a merchant device 608A/608B that are targeted at particular proxy identity information by using the proxy contact information. For example, the system provider device 602 may receive marketing materials from a merchant device 608A/608B associated with a merchant (e.g., “MINECRAFTGAMES.COM”) at the proxy contact information 416 (e.g., marketing emails received at the proxy email address 416A and/or marketing voice mail received at the proxy phone number 416B). For further example, the system provider device 602 may determine that the customer chooses to receive marketing materials from the merchant by using the proxy identity information 308 according to the marketing preference configuration 708, and associate the received marketing materials at the proxy contact information 416 with the proxy identity information 308 (e.g., in a marketing materials database).

In some embodiments, the customer may add, remove, and/or edit the various marketing preference configurations. For example, each of the marketing user groups 712 and merchant websites 714 of the marketing preference configurations may be editable and changed by the customer. In some embodiments, the customer may select the save button 716 if the customer would like to save the changes that the customer has made to marketing preference configurations.

Referring to FIGS. 1, 8, 9A, and 9B, the method 100 then proceeds to block 114, where the received marketing materials associated with the proxy identity information associated with the customer are provided to the customer according to marketing materials management configurations. In some embodiments, the customer may configure the marketing materials management configurations so that marketing materials associated with proxy identity information with different trust levels may be displayed to the customer differently. In an example, marketing materials associated with proxy identity information with a high trust level from the customer may be sent to the customer's real contact information or provide a notification on the customer's device, so that the customer may receive those marketing materials without delay. In another example, marketing materials associated with proxy identity information with a medium trust level from the customer may not be sent to the customer's real contact information, and the customer may review them in a dashboard provided by the system provider device when the customer logs in the system provider device. In yet another example, the customer may not be interested in any marketing materials associated with proxy identity information with a low trust level, and the system provider device may delete these marketing materials (e.g., from the marketing materials database).

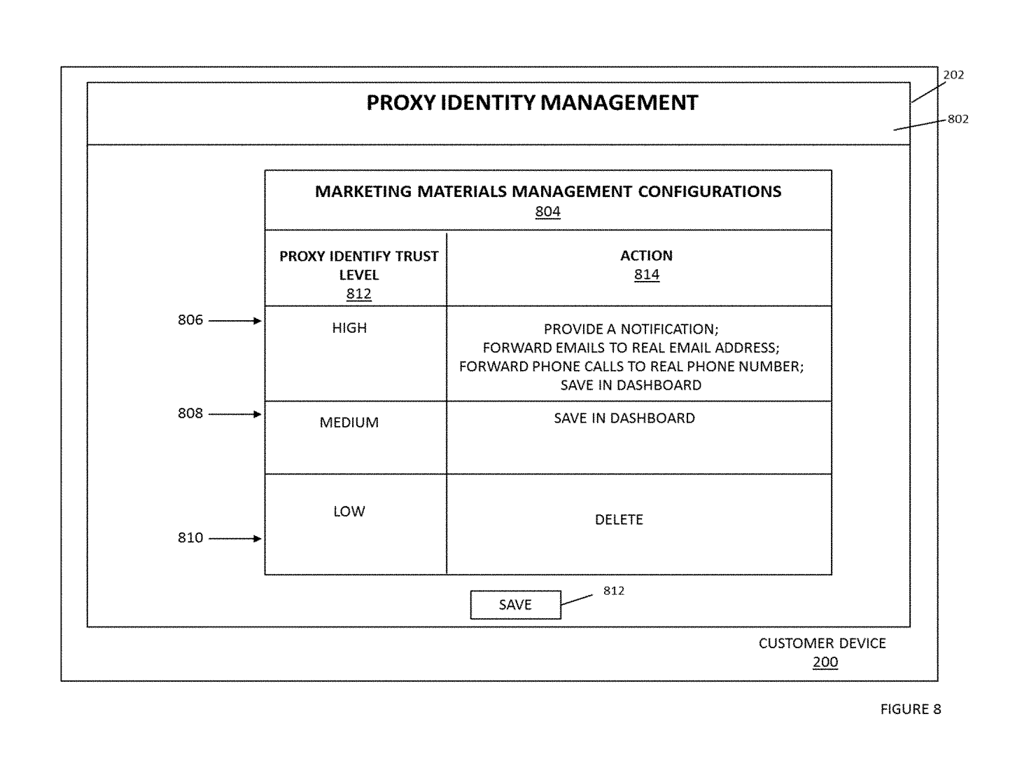

Referring now to the example of FIG. 8, illustrated is an example of a marketing materials management configurations screen 802 displayed on a display device 202 of a customer device 200. The marketing materials management configurations screen 702 includes a marketing materials management configuration section 804 including various marketing materials management configurations 806, 808, and 810. In an example, the marketing materials management configuration 806 may provide that for the proxy identity information that has a “HIGH” trust level (e.g., the proxy identity information 306), the system provider device 602 may forward the marketing materials received at the proxy contact information 416 to the customer's real contact information 660. For example, the system provider device 602 may provide a notification about the marketing materials on the customer device, forward the marketing emails received at the proxy email address 416A (e.g., “ELLEDRIVER@PROXYPROVIDER.COM”) to the real email address email address 660A (e.g., “DORRIS@HOTMAIL.COM”), forward the received marketing phone calls and/or voice messages at the proxy phone number 416B (e.g., “343-235-2111”) to the customer's real phone number 660B (e.g., “512-888-8888”), and display the received marketing materials in a dashboard provided by the system provider device 602. In another example, the marketing materials management configuration 808 may provide that for the proxy identity information that has a “MEDIUM” trust level (e.g., the proxy identity information 308), the system provider device 602 may display all the marketing materials associated with the proxy identity information in a dashboard of the system provider device 602 without forwarding the marketing materials to the real contact information of the customer. In another example, the marketing materials management configuration 806 may provide that for the proxy identity information that has a “LOW” trust level (e.g., the proxy identity information 310), the system provider device 602 may delete all of the received marketing materials associated with the proxy identity information.

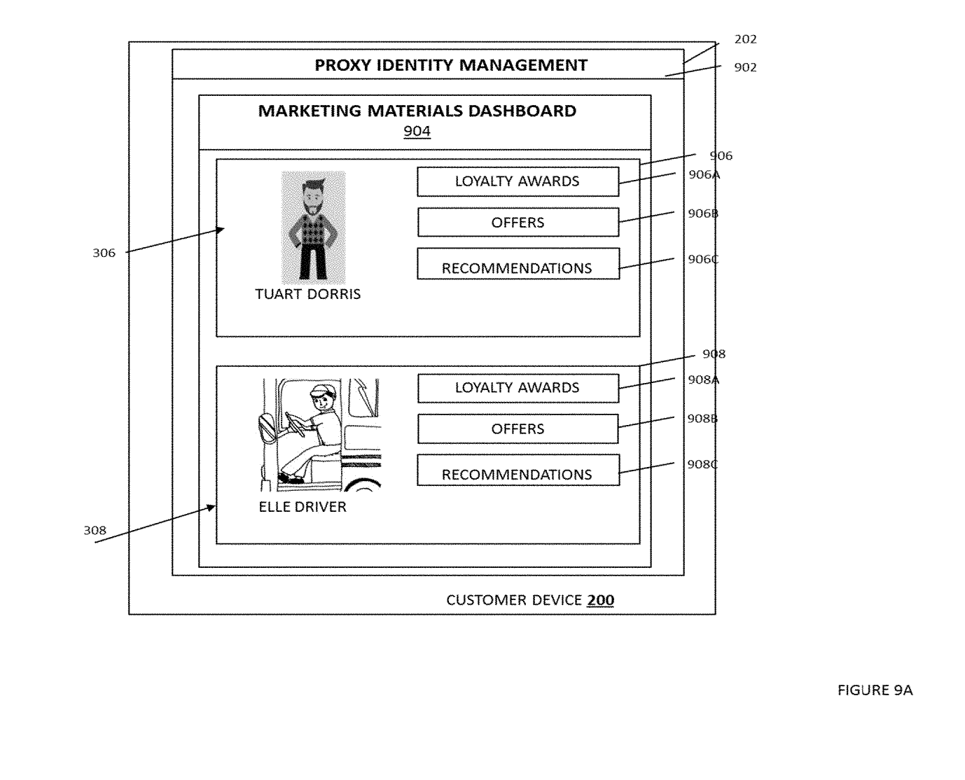

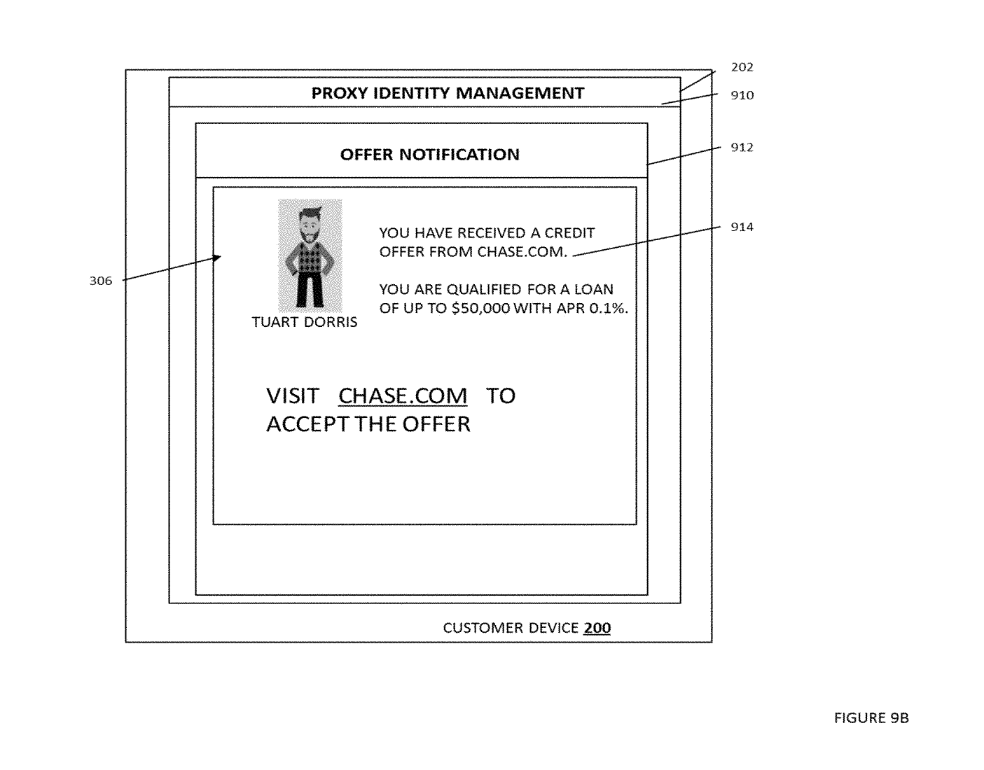

Referring now to FIG. 9A, illustrated is an embodiment of the customer device 200 displaying a marketing materials dashboard screen 902 including a marketing materials dashboard section 904. In an example, the marketing materials dashboard section 904 includes a section 906 displaying the marketing materials associated with the proxy identity information 306. According to the marketing materials management configuration 806, because the proxy identity information 306 has a trust level 410 of “HIGH,” the associated marketing materials are displayed on the dashboard provided by the system provider device 602. The customer may select the “Loyalty Awards” button 906A to review the loyalty awards associated with the proxy identity information 306, may select the “Offers” button 906B to review the offers associated with the proxy identity information 306, and may select the “Recommendations” button 906C associated with the proxy identity information 306. In another example, the marketing materials dashboard section 904 includes a section 908 displaying the marketing materials associated with the proxy identity information 308. According to the marketing materials management configuration 808, because the proxy identity information 308 has a trust level 410 of “MEDIUM,” the associated marketing materials are displayed on the dashboard provided by the system provider device 602. The customer may select the “Loyalty Awards” button 906A to review the loyalty awards associated with the proxy identity information 308, select the “Offers” button 906B to review the offers associated with the proxy identity information 308, and select the “Recommendations” button 906C associated with the proxy identity information 308. In another example, the marketing materials dashboard section 904 does not include any section displaying marketing materials associated with the proxy identity information 310 according to the marketing materials management configuration 810, where the associated marketing materials have been deleted by the system provider device 602.

Referring now to FIG. 9B, illustrated is an embodiment of the customer device 200 displaying an offer notification screen 910 including an offer notification section 912. In an example, the offer notification section 912 includes the marketing materials (e.g., a credit offer) associated with the proxy identity information 306 received from a merchant 914 (e.g., “CHASE.COM”). According to the marketing materials management configuration 806, because the proxy identity information 306 has a trust level 410 of “HIGH,” a notification of the credit offer is sent to the customer device 200. The examples illustrated in FIG. 9B are not intended to be limiting, and the notification may be provided to the customer device in a variety of manners (through a website, an application, as a message (e.g., an email, a text message, a picture message, a “pop-up”, a voice call, etc.) without departing from the scope of the present disclosure.

Thus, systems and methods for providing proxy identity management have been described that operate to provide merchants, customers, and marketing service providers a proxy identity management system for managing various proxy identities that may be provided to different merchants and used in receiving targeted marketing from marketing service providers without revealing the customers' true identities. The systems and methods allow customers to provide different proxy identities to different merchants, for example, based on the customer's trust levels in the merchants. The system provider device may act as an intermediary between the merchants and third party service providers, and provide proper real identity information to the third party service providers for the corresponding services provided by the third party service providers (e.g., shipping service, payment service). Furthermore, the proxy identities may provide proxy contact information that the system provider may use to receive marketing materials, thereby reducing spams at the customers' real email addresses and real phone numbers. The systems and methods may also allow customers to participate in various user groups to receive targeted marketing from marketing service providers without revealing the customers' real identity. Moreover, the system provider may provide the customers the convenience of managing the marketing materials from various merchants and marketing service providers in a single dashboard provided by the system provider.

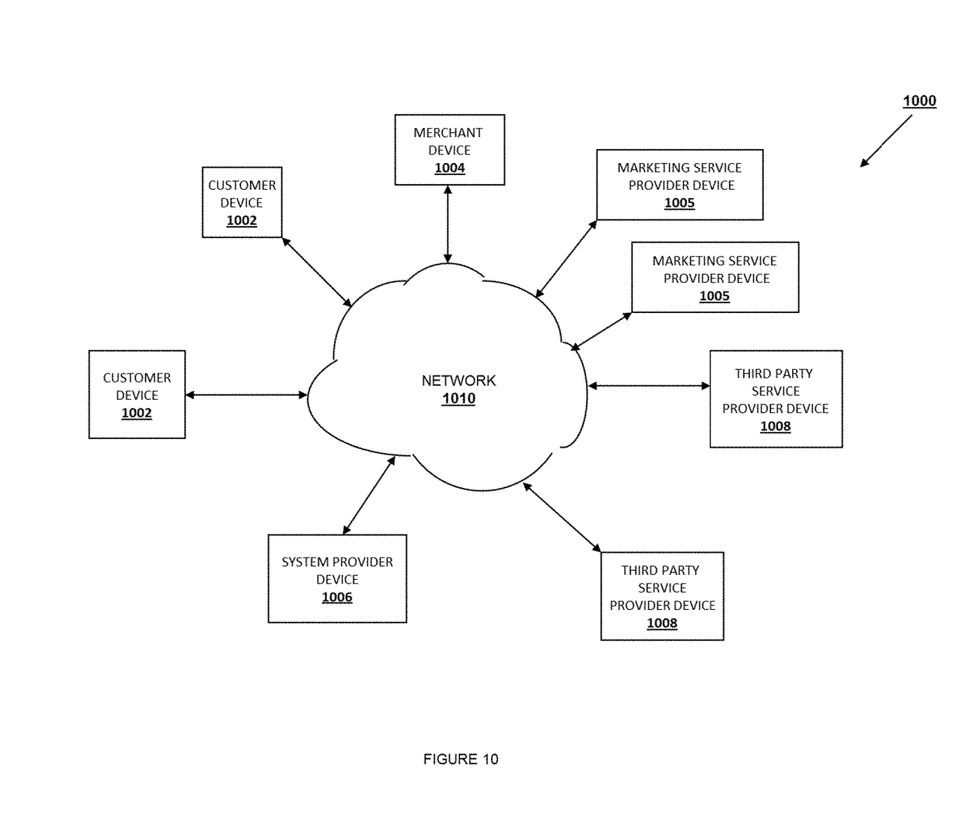

Referring now to FIG. 10, an embodiment of a network-based system 1000 for implementing one or more processes described herein is illustrated. As shown, network-based system 1000 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 10 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1000 illustrated in FIG. 10 includes a plurality of customer devices 1002, a plurality of merchant devices 1004, a plurality of marketing provider devices 1005, a system provider device 1006, and a plurality of thirsted third party service provider devices 1008 in communication over a network 1010. Any of the customer devices 1002 may be the customer devices 200 discussed above and used by the customer discussed above. Any of the merchant devices 1004 may be the merchant device 606 discussed above. Any of the marketing service provider devices 1005 may be the marketing service provider device 612 discussed above. Any of the third party service provider devices 1008 may be the third party service provider devices 608A and 608B discussed above. The system provider device 1006 may be the system provider device 602 discussed above and may be operated by a system provider such as, for example, PayPal Inc. of San Jose, Calif.

The customer devices 1002, merchant devices 1004, marketing service provider device 1005, system provider devices 1006, and third party service provider devices 1008 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1000, and/or accessible over the network 1010.

The network 1010 may be implemented as a single network or a combination of multiple networks. For example, in various embodiments, the network 1010 may include the Internet and/or one or more intranets, landline networks, wireless networks, and/or other appropriate types of networks.

The customer device 1002 may be implemented using any appropriate combination of hardware and/or software configured for wired and/or wireless communication over network 1010. For example, in one embodiment, the customer device 1002 may be implemented as a personal computer of a user in communication with the Internet. In some embodiments, the customer device 1002 may be a wearable device. In some embodiments, the customer device 1002 may be a smart phone, personal digital assistant (PDA), laptop computer, and/or other types of computing devices.

The customer device 1002 may include one or more browser applications which may be used, for example, to provide a convenient interface to permit the customer to browse information available over the network 1010. For example, in one embodiment, the browser application may be implemented as a web browser configured to view information available over the Internet.

The customer device 1002 may also include one or more toolbar applications which may be used, for example, to provide user-side processing for performing desired tasks in response to operations selected by the customer. In one embodiment, the toolbar application may display a user interface in connection with the browser application.

The customer device 1002 may further include other applications as may be desired in particular embodiments to provide desired features to the customer device 1002. The other applications may also include security applications for implementing user-side security features, programmatic user applications for interfacing with appropriate application programming interfaces (APIs) over the network 1010, or other types of applications. Email and/or text applications may also be included, which allow the customer to send and receive emails and/or text messages through the network 1010. The customer device 1002 includes one or more user and/or device identifiers which may be implemented, for example, as operating system registry entries, cookies associated with the browser application, identifiers associated with hardware of the customer device 1002, or other appropriate identifiers, such as a phone number. In one embodiment, the customer identifier may be used by the system provider device 1006 to associate the customer with a particular account as further described herein.

The merchant devices 1004 may be maintained, for example, by a conventional or on-line merchant, conventional or digital goods seller, individual seller, and/or application developer offering various products and/or services in exchange for payment to be received conventionally or over the network 1010. In this regard, the merchant devices 1004 may include a database identifying available products and/or services (e.g., collectively referred to as items) which may be made available for viewing and purchase by the customers.

The merchant devices 1004 also include a checkout application which may be configured to facilitate the purchase by the customers. The checkout application may be configured to accept payment information from the customer through the customer devices 1002, from the system provider through the system provider device 1006, and/or other system providers over the network 1010.

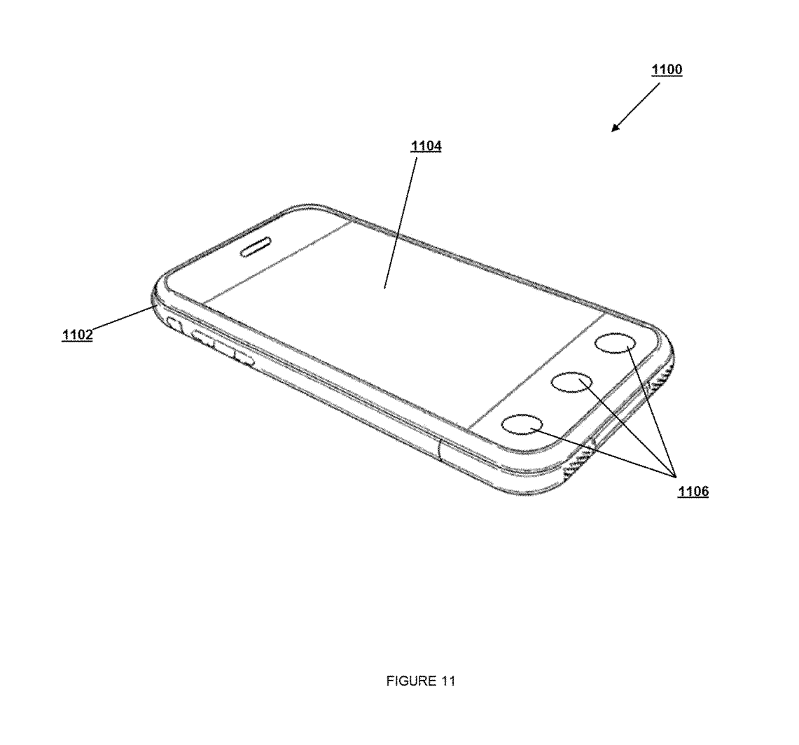

Referring now to FIG. 11, an embodiment of a customer device 1100 is illustrated. The customer device 1100 may be the customer devices 200. The customer device 1100 includes a chassis 1102 having a display 1104 and an input device including the display 1104 and a plurality of input buttons 1106. One of skill in the art will recognize that the customer device 1100 is a portable or mobile phone including a touch screen input device and a plurality of input buttons that allow the functionality discussed above with reference to the method 100. However, a variety of other portable/mobile customer devices may be used in the method 100 without departing from the scope of the present disclosure.

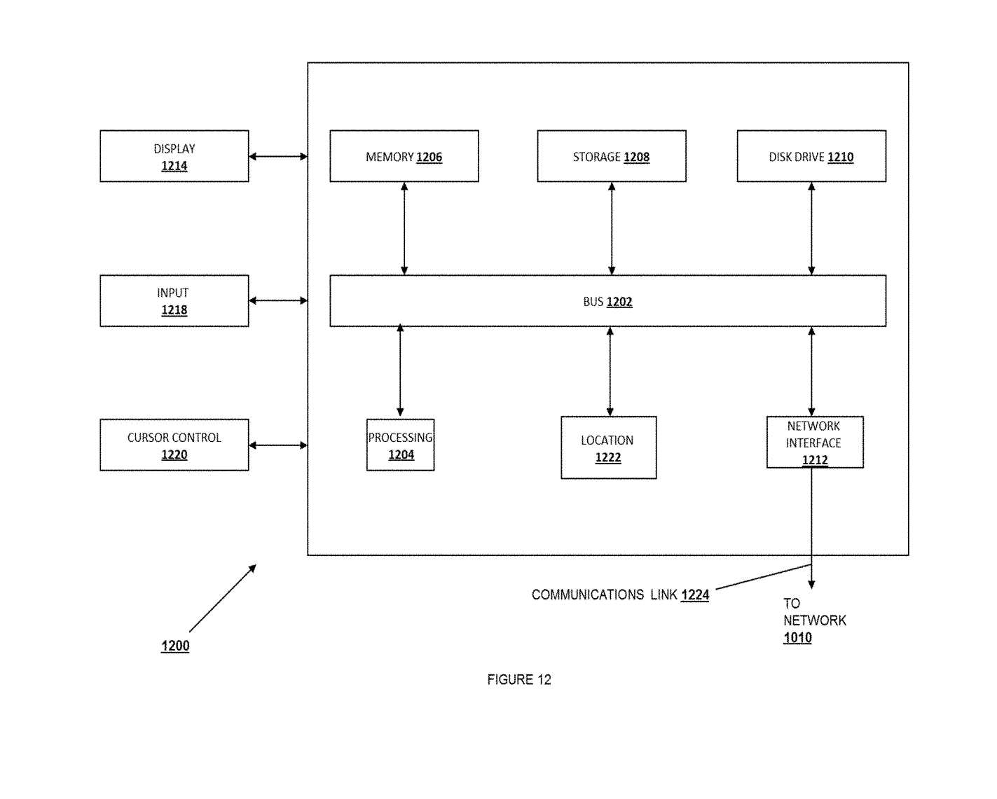

Referring now to FIG. 12, an embodiment of a computer system 1200 suitable for implementing, for example, the system provider devices 602, merchant devices 606, and/or customer device 200, is illustrated. It should be appreciated that other devices utilized by users, persons, and/or system providers in the system discussed above may be implemented as the computer system 1200 in a manner as follows.

In accordance with various embodiments of the present disclosure, computer system 1200, such as a computer and/or a network server, includes a bus 1202 or other communication mechanism for communicating information, which interconnects subsystems and components, such as a processing component 1204 (e.g., processor, micro-controller, digital signal processor (DSP), etc.), a system memory component 1206 (e.g., RAM), a static storage component 1208 (e.g., ROM), a disk drive component 1210 (e.g., magnetic or optical), a network interface component 1212 (e.g., modem or Ethernet card), a display component 1214 (e.g., CRT or LCD), an input component 1218 (e.g., keyboard, keypad, or virtual keyboard), a cursor control component 1220 (e.g., mouse, pointer, or trackball), and a location sensor component 1222 (e.g., a Global Positioning System (GPS) device as illustrated, a cell tower triangulation device, and/or a variety of other location determination devices known in the art). In one implementation, the disk drive component 1210 may comprise a database having one or more disk drive components.

In accordance with embodiments of the present disclosure, the computer system 1200 performs specific operations by the processor 1204 executing one or more sequences of instructions contained in the memory component 1206, such as described herein with respect to the customer device(s) 200, the merchant devices 606, the marketing service provider device 612, the third party service provider devices 608A and 608B, and/or the system provider device(s) 602. Such instructions may be read into the system memory component 1206 from another computer readable medium, such as the static storage component 1208 or the disk drive component 1210. In other embodiments, hard-wired circuitry may be used in place of or in combination with software instructions to implement the present disclosure.

Logic may be encoded in a computer readable medium, which may refer to any medium that participates in providing instructions to the processor 1204 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1210, volatile media includes dynamic memory, such as the system memory component 1206, and transmission media includes coaxial cables, copper wire, and fiber optics, including wires that comprise the bus 1202. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1200. In various other embodiments of the present disclosure, a plurality of the computer systems 1200 coupled by a communication link 1224 to the network 1010 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1200 may transmit and receive messages, data, information and instructions, including one or more programs (i.e., application code) through the communication link 1224 and the network interface component 1212. The network interface component 1212 may include an antenna, either separate or integrated, to enable transmission and reception via the communication link 1224. Received program code may be executed by processor 1204 as received and/or stored in disk drive component 1210 or some other non-volatile storage component for execution.

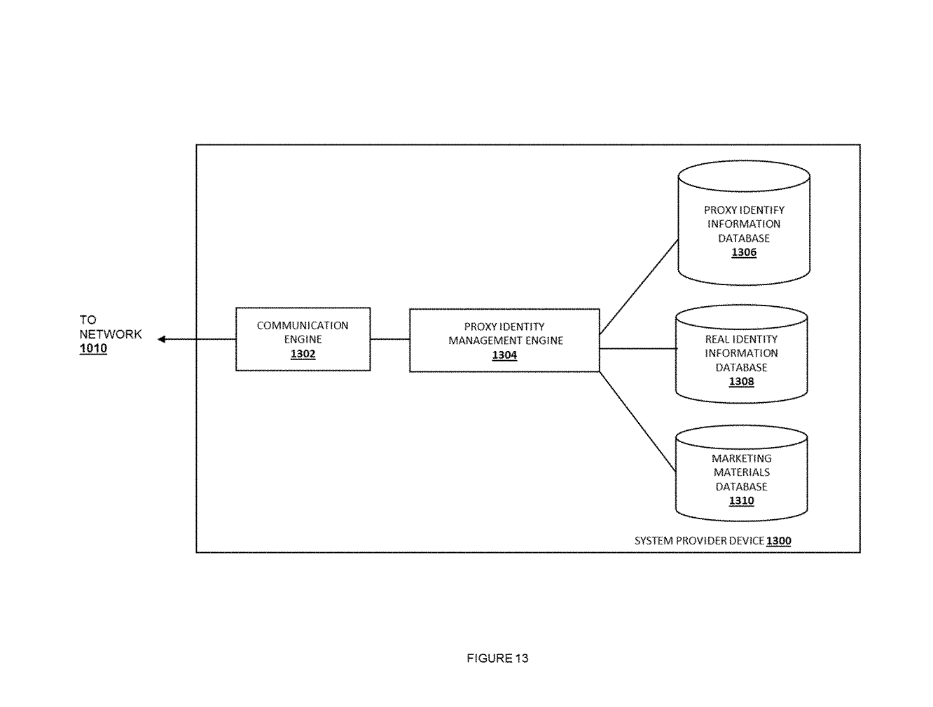

Referring now to FIG. 13, an embodiment of a system provider device 1300 is illustrated. In an embodiment, the system provider device 1300 may be the system provider devices 602 discussed above. The system provider device 1300 includes a communication engine 1302 that is coupled to the network 1010 and to a proxy identity management engine 1304 that is coupled to a proxy identity information database 1306, a real identity information database 1308, and a marketing materials database 1310. In an embodiment, the proxy identity information database 1306 may be the proxy identity information database 610 discussed above, and the real identity information database 1308 may be the real identity information database 612 discussed above. The communication engine 1302 may be software or instructions stored on a computer-readable medium that allows the system provider device 1300 to send and receive information over the network 1010. The personal information certification and management engine 1304 may be software or instructions stored on a computer-readable medium that is operable to receive a first proxy identifier associated with a first website, associate the first proxy identifier with first proxy identity information, provide to the first device the first proxy identity information, receive from a marketing service provider device first marketing information associated with the first proxy identity information, provide the first marketing information for display on a customer device according to a first marketing materials management configuration, and provide any of the other functionality that is discussed above. While the databases 1306, 1308, and 1310 have been illustrated as separate from each other and located in the system provider device 1300, one of skill in the art will recognize that any or all of the databases 1306, 1308, and 1310 may be combined and/or may be connected to the proxy identity management engine 1304 through the network 1010 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A proxy identity management system, comprising:
a non-transitory memory storing one or more marketing materials management configurations that are associated with an actual identity; and
one or more hardware processors configured to execute instructions to cause the system to perform operations comprising:
receiving, from a first device through a network, a first proxy identifier associated with a first website;
associating, in the non-transitory memory system, the first proxy identifier with first proxy identity information, the first proxy identifier being one of one or more proxy identifiers corresponding to the actual identity;
providing, over the network to the first device, the first proxy identity information;
determining that first marketing information, received from a marketing service provider device through the network, corresponds the first proxy identity information;
retrieving, from the non-transitory memory, a first marketing materials management configuration of the one or more marketing materials configurations associated with the actual identity, the first marketing management materials configuration being selected for retrieval based on the first proxy identity information; and
providing the first marketing information over the network for display on a customer device according to the first marketing materials management configuration.

2. The system of claim 1, wherein the operations further comprise:
receiving, from a service provider device through the network, at least partially the first proxy identity information; and
providing, over the network to the service provider device, real identity information associated with the at least partially first proxy identity information.

3. The system of claim 2, wherein the service provider device provides a shipping service, and wherein the real identity information includes real shipping address information.

4. The system of claim 3, wherein the operations further comprise:
providing, over the network to the first device, shipping cost information determined based on the real shipping address information.

5. The system of claim 1, wherein the operations further comprise:
receiving the first marketing information using first proxy contact information of the first proxy identity information; and
providing the first marketing information to the customer device using real contact information associated with the customer.

6. The system of claim 1, wherein operations further comprise:
associating a first user group with the first proxy identity information according to a first marketing preference configuration;
receiving, from the marketing service provider device through the network, first user group marketing information targeted at the first user group; and
associating the first user group marketing information with the first proxy identity information.

7. The system of claim 6, wherein the operations further comprise:
associating a second user group with second proxy identity information according to a second marketing preference configuration;
receiving, from the marketing service provider device through the network, second user group marketing information targeted at the second user group; and
associating the second user group marketing information with the second proxy identity information.

8. A method, comprising:
storing, in a database, one or more marketing materials configurations that are associated with an actual identity;
receiving, from a first device through a network, a first proxy identifier associated with a first website;
associating, in the database, the first proxy identifier with first proxy identity information, the first proxy identifier being one of one or more proxy identifiers corresponding to the actual identity;
providing, over the network to the first device, the first proxy identity information;
determining that first marketing information, received from a marketing service provider device through the network, corresponds the first proxy identity information;
retrieving, from the database, a first marketing materials management configuration of the one or more marketing materials configurations associated with the actual identity, the first marketing management materials configuration being selected for retrieval based on the first proxy identity information; and
providing the first marketing information over the network for display on a customer device according to the first marketing materials management configuration.

9. The method of claim 8, further comprising:
receiving, from a service provider device through the network, at least partially the first proxy identity information; and
providing, over the network to the service provider device, real identity information associated with the at least partially first proxy identity information.

10. The method of claim 9, wherein the service provider device provides a shipping service, and wherein the real identity information includes real shipping address information.

11. The method of claim 10, further comprising:
providing, over the network to the first device, shipping cost information determined based on the real shipping address information.

12. The method of claim 8, further comprising:
receiving the first marketing information using first proxy contact information of the first proxy identity information; and
providing the first marketing information to the customer device using real contact information associated with the customer.

13. The method of claim 8, further comprising:
associating a first user group with the first proxy identity information according to a first marketing preference configuration;
receiving, from the marketing service provider device through the network, first user group marketing information targeted at the first user group; and
associating the first user group marketing information with the first proxy identity information.

14. The method of claim 13, further comprising:
associating a second user group with second proxy identity information according to a second marketing preference configuration;
receiving, from the marketing service provider device through the network, second user group marketing information targeted at the second user group; and
associating the second user group marketing information with the second proxy identity information.

15. A non-transitory computer-readable medium having machine-readable instructions executable to cause a machine to perform operations comprising:
storing, in a database, one or more marketing materials configurations that are associated with an actual identity;
receiving, from a first device through a network, a first proxy identifier associated with a first website;
associating, in the database, the first proxy identifier with first proxy identity information, the first proxy identifier being one of one or more proxy identifiers corresponding to the actual identity;
providing, over the network to the first device, the first proxy identity information;
determining that first marketing information, received from a marketing service provider device through the network, corresponds the first proxy identity information;
retrieving, from the database, a first marketing materials management configuration of the one or more marketing materials configurations associated with the actual identity, the first marketing management materials configuration being selected for retrieval based on the first proxy identity information; and
providing the first marketing information over the network for display on a customer device according to the first marketing materials management configuration.

16. The non-transitory machine-readable medium of claim 15, wherein the operations further comprise:
receiving, from a service provider device through the network, at least partially the first proxy identity information; and
providing, over the network to the service provider device, real identity information associated with the at least partially first proxy identity information.

17. The non-transitory machine-readable medium of claim 16, wherein the service provider device provides a shipping service, and wherein the real identity information includes real shipping address information.

18. The non-transitory machine-readable medium of claim 17, wherein the operations further comprise:
providing, over the network to the first device, shipping cost information determined based on the real shipping address information.

19. The non-transitory machine-readable medium of claim 15, wherein the operations further comprise:
receiving the first marketing information using first proxy contact information of the first proxy identity information; and
providing the first marketing information to the customer device using real contact information associated with the customer.

20. The non-transitory machine-readable medium of claim 15, wherein the operations further comprise:
associating a first user group with the first proxy identity information according to a first marketing preference configuration;
receiving, from the marketing service provider device through the network, first user group marketing information targeted at the first user group; and
associating the first user group marketing information with the first proxy identity information.
